(19) United States
(12) Patent Application Publication
(10) Pub. No.: US 2014/0286524 A1
(43) Pub. Date: Sep. 25, 2014

(54) LOUD SPEAKERS

(71) Applicant: Tannoy Limited, Coatbridge (GB)

(72) Inventor: Philippe Jean-Baptiste ROBINEAU, Coatbridge (GB)

(73) Assignee: Tannoy Limited, Coatbridge (GB)

(21) Appl. No.: 14/201,168

(22) Filed: Mar. 7, 2014

(30) Foreign Application Priority Data
Mar. 25, 2013 (GB) 1305412.7

(51) Int. Cl. H04R 3/00; H04R 15/00

(52) U.S. Cl. CPC H04R 3/00; H04R 15/00
USPC 381/412

(57) ABSTRACT

A magnetic assembly and a loudspeaker use a magnetic assembly are. The magnetic assembly has a pole piece that is designed to form an outer air gap and an inner air gap for coaxial voice coils of the loudspeaker. The same magnet is used for the magnetic circuits of the two voice coils. The pole piece is shaped to split the magnetic circuits into a low frequency magnetic circuit and a high frequency magnetic circuit. A convex dome is attached to the high frequency voice coil.

This application claims benefit of Ser. No. 1305412.7, filed 25 Mar. 2013 in Great Britain and which application is incorporated herein by reference. To the extent appropriate, a claim of priority is made to the above disclosed application.

### FIELD OF INVENTION

The present invention relates to a loudspeaker and to parts thereof. The invention has particular relevance to electro-dynamic loudspeakers known as moving coil loudspeakers and more especially those of the type commonly referred to as coaxial.

### BACKGROUND OF INVENTION

A coaxial loudspeaker has two sound producing elements—a low frequency (LF) element and a high frequency (HF) element, each of them having their own moving assembly including a voice coil. The LF and HF elements have their central radiation axis coincident, so that they produce a coherent wave front.

Broadly speaking there are two types of coaxial loudspeaker. In one, the HF element radiates according to the principle of what is known in the industry as compression drive which relies on a horn to guide the HF wave propagation, resulting in controlled directivity and enhanced sensitivity by acoustic impedance matching. In some implementations the role of the horn is played by the membrane (cone) of the LF element, in others a dedicated horn, inserted in front of the LF cone, is used. In the second type of coaxial loudspeaker the HF element simply comprises a conventional tweeter mechanically secured in front of the LF cone; and the HF element therefore works as a direct radiator as opposed to being horn loaded like in the first type discussed in the preceding paragraph.

If the coaxial concept has some inherent technical advantages, the constraints it brings tend to result in higher manufacturing costs. One of them is the requirement for each coil (LF or HF) to operate in a separate magnetic annular gap, the two gaps having to be concentric to fulfill the condition for coincident radiation axes.

Several methods have been tried in the past to simplify the magnetic assembly of coaxial drivers in order to make them more cost-effective, the first obvious goal being to use only one magnet instead of two.

An early example of a coaxial design using a single magnet is described in U.S. Pat. No. 2,539,672 (1951) by H. Olson. However it should be noted that the permanent magnet used by Olson has a cylindrical shape, and occupies a central location in the mechanical structure. Although it is not explicitly stated by Olson in his patent, it is clear that the magnet material is Alnico, which was the most popular material for loudspeaker magnets at the time. The cost of this material has now become prohibitive such that no cost-effective design can be based on this material nowadays. Today, the two magnet materials commonly in use are ferrite (inexpensive but bulky) and neodymium (very compact and expensive). Ferrite, the less expensive solution, practically dictates the use of a ring shaped magnet.

A later patent by A. Garner (U.S. Pat. No. 4,256,930, 1981) describes another coaxial driver design using a single permanent magnet. In Garner's design, shown in FIG. 4, the magnet 101 is ring shaped as has become the norm for ferrite magnets. As far as the HF element is concerned, this design is of the compression drive type, with a moving diaphragm 110 radiating inwards into air channels through a pole piece 108. These channels extend to a central passage 109 forming a horn as it flares outwards. With respect to the direction of propagation, the HF diaphragm 110 forms a concave dome, which is a very common feature that suits this particular driver design. This is directly related to the fact that the diaphragm 110 is located behind the magnetic assembly made of ring magnet 101, top plate 102, pole piece 108, and rear plate 103. Similarly the air gap intended to receive the voice coil 112 is located at the rear of the magnetic assembly.

Although Garner's design is still popular, it has an inherent shortcoming in the use of the concave dome design 110. In particular, the HF sound eventually propagates within the waveguide as a portion of a diverging spherical wave, but with a concave dome it has to start as a converging wave, then reach an acoustic focal point before expanding again. This adds to the propagation path, and is detrimental to a proper time alignment between the LF and HF elements. In addition, distortion is increased as in this initial propagation path the wave travels with a high acoustic intensity due to the narrow cross-sectional area.

Other more recent attempts to design a single magnet coaxial loudspeaker include the one proposed by J. Peng in U.S. patent 2003/0206641 (2003), which is illustrated in FIG. 5. As shown, the magnetic assembly comprises a ring-shaped magnet 155, a reversed T-shaped pole piece 153 forming together with outer C-shape plate 154 a dual air gap for voice coils 151 and 152. It appears from the drawings of Peng that the HF element of this driver is of the direct radiating type, rather than the compression drive type. The simplicity of this design however relies on the magnet being an internal part of the HF structure, but this limits the size of the magnet and as a result is likely to dictate the use of neodymium which is an expensive material.

The present invention aims to provide an alternative magnetic assembly for a loudspeaker design and to provide an alternative coaxial loudspeaker design using the new magnetic assembly.

### SUMMARY OF INVENTION

According to one aspect, the present invention provides a magnetic assembly for a loudspeaker comprising: a magnet for producing a magnetic field; a top plate provided adjacent a top surface of the magnet; a rear plate provided adjacent a rear surface of the magnet; a pole piece positioned adjacent the top plate and the rear plate; a first projection that projects from an inside surface of the pole piece; a second projection that projects from a surface of the rear plate; wherein the pole piece and the top plate are positioned adjacent each other to define a first air gap for a first voice coil; wherein the first projection and the second projection are arranged adjacent each other to define a second air gap for a second voice coil.

In one embodiment, the pole piece and the rear plate are positioned adjacent each other to define a third gap. The third gap may be defined by one or more non-magnetic spacers that locate and fix the pole piece relative to the rear plate. The spacer may be dimensioned so that the third gap is between 1 mm and 2 mm.

Preferably the magnet is a ring magnet typically made from a ferrite material; and the top plate and the rear plate have an annular shape. In this case, the pole piece is positioned within an inner edge of the annular top plate and may be substantially cylindrical in shape. The first projection may be annular shape and may be formed on an inside surface of the cylindrical pole piece. The first projection may be positioned closer to a base of the pole piece than to a top of the pole piece and will typically be integrally formed with the pole piece.

In the preferred embodiment, the pole piece, the first and second projections, the top plate and the rear plate are arranged so that the first air gap and the second air gap are annular having a common central axis. This allows the magnetic assembly to be used in a coaxial loudspeaker design.

The present invention also provides a loudspeaker comprising: the above described magnetic assembly, a frame coupled to the magnetic assembly; a first voice coil mounted within the first air gap; a cone attached between the frame and the first voice coil; a second voice coil mounted within the second air gap; and a dome attached to the second voice coil.

In one embodiment, the dome is convex in shape relative to a propagation direction of a sound wave produced by the loudspeaker and the first and second voice coils are coaxial and arranged so that sound waves produced by the dome are guided by the cone.

A phase corrector may be positioned in front of the dome for correcting a phase of the sound wave produced by the dome.

Typically, the second voice coil has a smaller diameter than the diameter of the first voice coil.

The present invention also provides a magnetic assembly for a loudspeaker, the magnetic assembly comprising a pole piece that is designed to form an outer air gap and an inner air gap for coaxial voice coils of the loudspeaker; and a magnet magnetically coupled to the pole piece; wherein the pole piece is shaped to define a first magnetic circuit which couples through the outer air gap and a second magnetic circuit which couples through the inner air gap.

### BRIEF DESCRIPTION OF THE DRAWINGS

These and other aspects of the invention will become apparent from the following detailed description of an exemplary embodiment which is described with reference to the accompanying drawings in which:

FIG. 1 is a cross-sectional view of a coaxial loudspeaker design embodying the present invention;

FIG. 2a illustrates in more detail a magnetic assembly of the loudspeaker shown in FIG. 1;

FIG. 2b is an exploded cross-sectional perspective view showing in more detail the structure of the magnetic assembly;

FIG. 2c illustrates the different magnetic flux paths through the magnetic assembly shown in FIG. 2a;

FIG. 3a is a cross-sectional view of a coaxial loudspeaker design embodying the present invention;

FIG. 3b is a perspective view from the front showing in more detail the structure of a phase corrector used in the loudspeaker shown in FIG. 3a;

FIG. 3c is a perspective view from the rear showing in more detail the structure of the phase corrector used in the loudspeaker shown in FIG. 3a;

FIG. 4 is a cross-sectional view of a prior art loudspeaker design; and

FIG. 5 is a cross-sectional view of a further prior art loudspeaker design.

### DETAILED DESCRIPTION

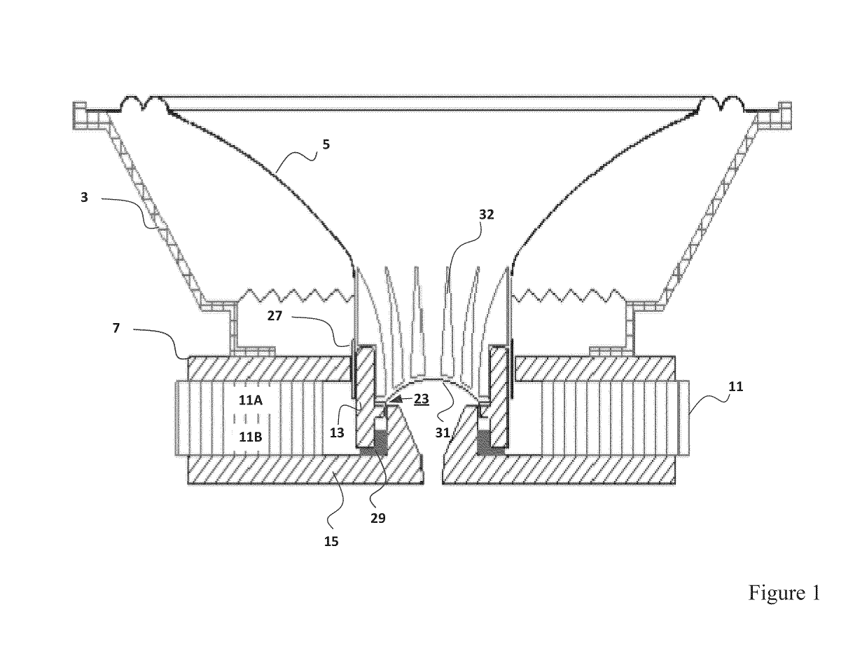

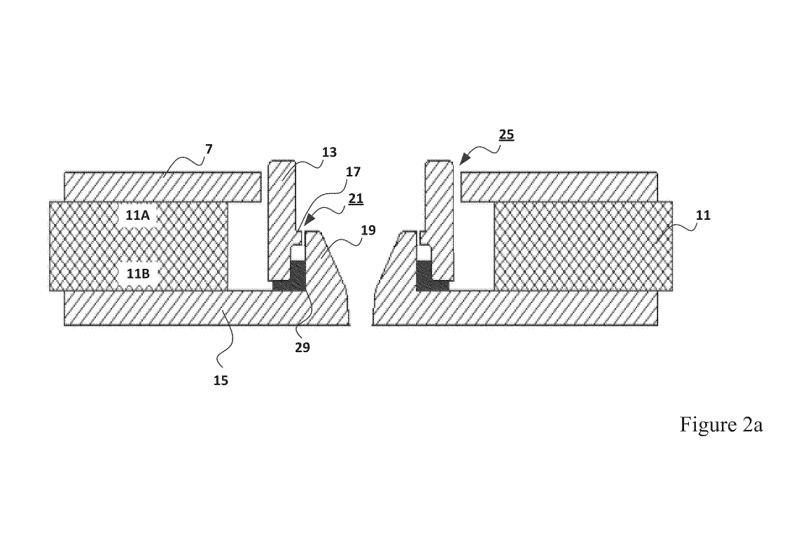

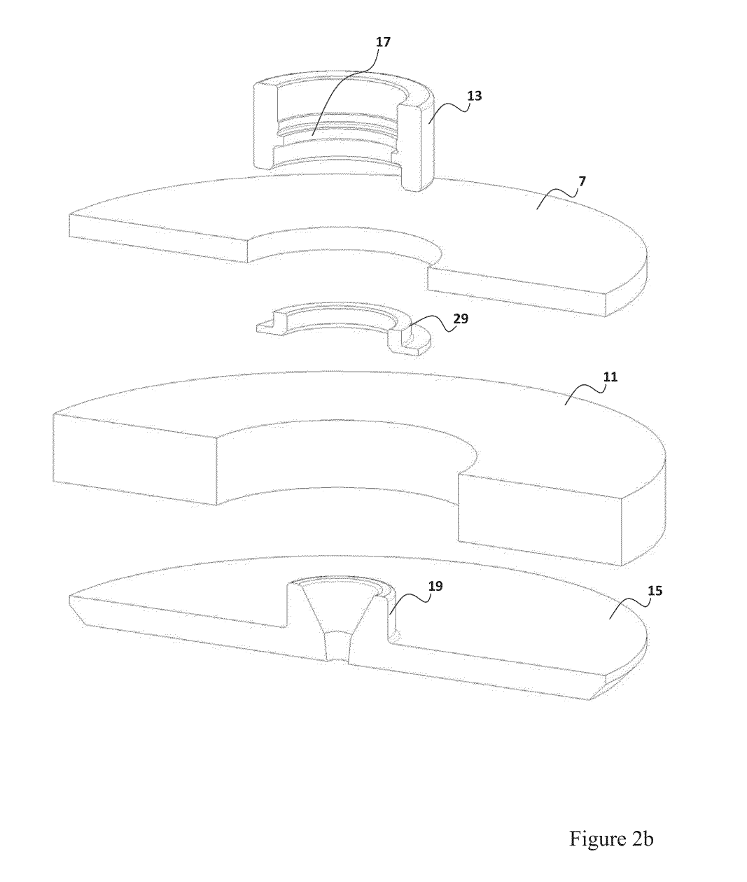

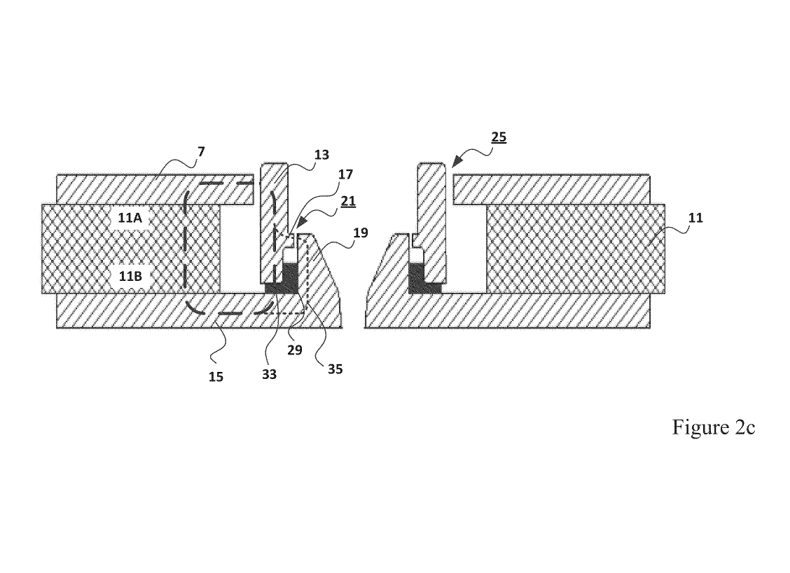

FIG. 1 shows in cross-section the new coaxial loudspeaker 1 embodying the present invention. The speaker has a frame 3 that supports the low frequency (LF) cone 5. The frame 3 is secured to a top plate 7 of a magnetic assembly generally indicated by reference numeral 9. The magnetic assembly 9 is shown in more detail in FIG. 2.

As can be seen from FIGS. 2a and 2b, the magnetic assembly 9 includes a ring magnet 11 (which in this embodiment is made of ferrite material), the top plate 7, a pole piece 13 and a rear plate 15. In this embodiment, the top plate 7, the rear plate 15 and the pole piece 13 are made of good magnetic conductors, such as iron or steel. The pole piece 13 is generally cylindrical having a lower annular projection 17 on an inner surface thereof that faces an upstanding annular projection 19 of the rear plate 15. An annular air gap 21 is provided between the annular projections 17 and 19 in which the high frequency (HF) voice coil 23 (shown in FIG. 1) is mounted. An annular air gap 25 is also provided between the top plate 7 and the outer circumference of the pole piece 13 in which the LF voice coil 27 (shown in FIG. 1) is mounted. A non-magnetic annular spacer 29 is provided for locating and securing the pole piece 13 relative to the rear plate 15. The rear plate 15, the spacer 29 and the pole piece 13 are bonded as an assembly with adhesive. Typically, the spacer 29 is made of aluminium and has a thickness so that the gap between the base of the pole piece 13 and the top surface of the rear plate 15 is between 1 mm and 2 mm.

Typically, the loudspeaker 1 has a frequency range of between about 30 Hz and 20 kHz, with the cross-over point defining the boundary between low frequencies and high frequencies being within the 1 kHz to 3 kHz range.

Returning to FIG. 1, the LF cone 5 is attached to the LF coil 27, so that when it moves, the LF cone 5 moves to generate the LF sound pressure waves. As shown in FIG. 1, a convex dome 31 is attached to the HF coil 23 so that it moves with movement of the HF coil 23 to produce the HF sound pressure waves. These sound waves travel through a thin cavity referred to as the “compression chamber” before reaching the entry point or “throat” of a phase corrector 32. The sound waves then propagate through the phase corrector (whose cross-section expands) to the cone 5 which acts as the final waveguide. The phase corrector 32 aids in keeping the sound signals produced by different parts of the dome 31 in-phase with each other as they emerge from the different channels of the phase corrector 32, so that the sound waves do not cancel each other out.

In operation, when the electrical current flowing through the HF coil 23 or the LF coil 27 changes direction, the coil's polar orientation reverses. Due to the presence of a static magnetic field, the current generates an electro-dynamic force F which is proportional to the current I and the magnetic flux density B. Low frequency signals are applied to the LF coil 27 so that the LF cone 5 produces low frequency sounds and high frequency signals are applied to the HF coil 23 so that the HF dome 31 produces high frequency sounds.

The magnetic assembly 9 has been designed to minimise distortion caused by using a common pole piece 13 for both the LF magnetic circuit and the HF magnetic circuit. The way that this magnetic assembly 9 operates can be described as follows. Assuming magnet 11 is energized, as in a conventional design, a magnetic circuit is created and magnetic flux circulates between the two poles 11A and 11B of the magnet 11. Also, as in a conventional design, the magnetic flux passes through the air gap 25 created between top plate 7 and the outer surface of the pole piece 13. At this point the new design differs from the conventional one so that the magnetic path splits in two, with a first path 33 (shown in FIG. 2c) returning to the rear plate 15 through the non-magnetic spacer 29; and with a second path 35 (shown in FIG. 2b) returning to the rear plate 15 through the air gap 21 between projections 17 and 19. The pole piece 13 and spacer 29 are designed to balance the magnetic flux passing through the air gap 21. In particular, the LF magnetic circuit generally requires higher energy compared to the HF magnetic circuit. As a common pole piece 13 is being used for both LF and HF magnetic circuits, without the flux path via the spacer 29, all of the LF magnetic flux would also pass through the air gap 21 for the HF coil and this will change the balance between the LF sounds and the HF sounds. However, by providing the return path via the spacer 29, a proper balance between the LF magnetic circuit and the HF magnetic circuit can be obtained.

### Modifications and Alternatives

A detailed embodiment has been described above. As those skilled in the art will appreciate, a number of modifications and alternatives can be made to the above embodiment whilst still benefiting from the inventions embodied therein. By way of illustration only some of these alternatives and modifications will now be described.

In the above embodiment, the projection 19 formed an integral part of the rear plate 15. As those skilled in the art will appreciate, the projection may be a separate component that is attached to the rear plate 15, for example by welding or by a mechanical fixture. Alternatively, the projection 19 may be formed on one plate that co-operates with a second plate (of simpler construction) to form the rear plate 15. This dual plate approach can be used to reduce the manufacturing cost as the more complicated plate with the projection 19 can be made out of a plate with a smaller diameter than that of the second plate. This arrangement makes it easier to machine the plate having the projection and leads to less waste. Similarly, the projection 17 on the pole piece 13 may be integrally formed with the pole piece 13 or it may be a separate component that is attached to the pole piece 13 by a mechanical fixture such as by a screw or by welding.

In the above embodiment, a ring shaped spacer 29 was used to locate and fix the pole piece 13 relative to the rear plate 15. It is not essential to use a ring shaped spacer—a plurality of discrete spacers may be provided distributed around the circular edge between the upstanding projection 19 and the top surface (closest to the cone 5) of the rear plate 15.

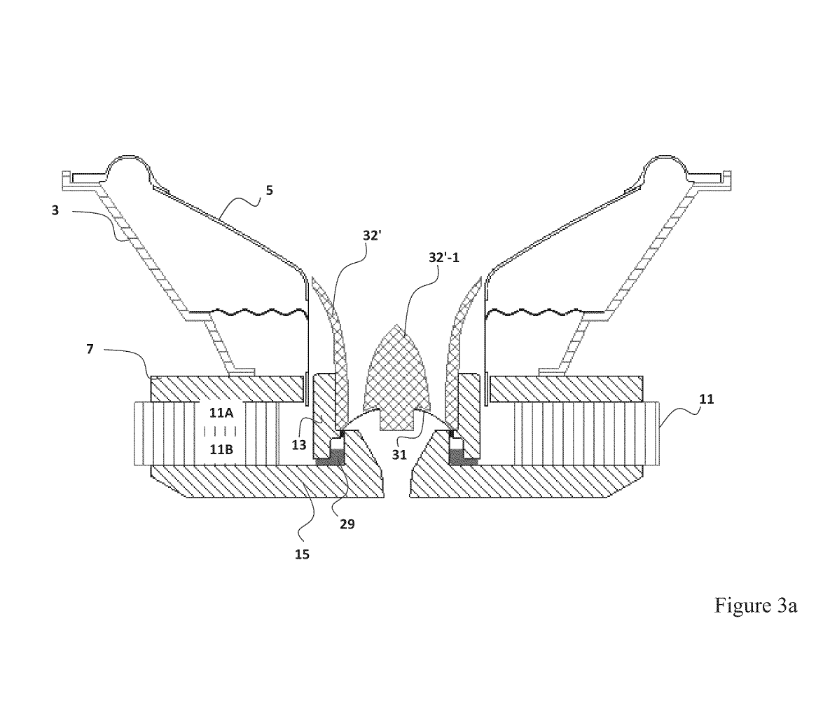

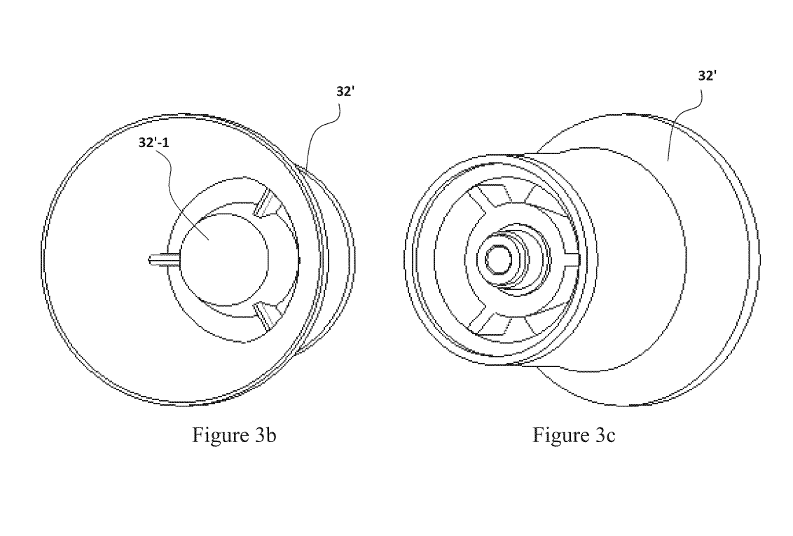

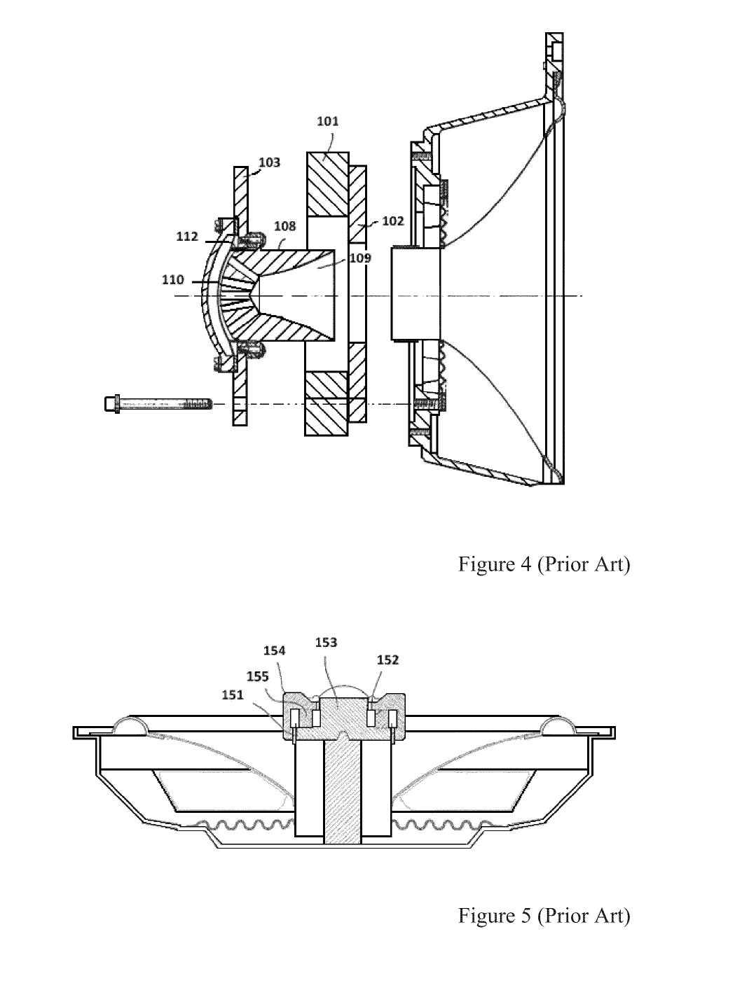

FIG. 3a illustrates an alternative loudspeaker design that uses a different phase corrector 32′. FIGS. 3b and 3c are front and rear perspective views of the alternative phase corrector 32′. The other features of the loudspeaker design are the same as in the first embodiment and a further description of these components will not be given again. In this embodiment, the central part of the dome 31 is clamped to a bullet shaped central portion 32′-1 of the phase corrector 32′. Acoustic analysis shows that most of the energy radiated by the HF dome 31 is generated by its peripheral region rather than its central region. This is because the acoustic volume velocity is proportional to the area of the moving surface. As an example, on a 25 mm diameter dome the central 10 mm only contributes about 16% of the overall acoustic energy produced by the dome. Also, relatively large domes 31 are generally undesirable as they tend to create problems of acoustical modes in ducts and cavities, and mechanical break-up in the diaphragm, at proportionally lower frequencies thus limiting the usable bandwidth.

The alternative phase corrector and dome design shown in FIG. 3 can alleviate these issues. In effect, by clamping (fixing) the central part of the dome 31 to the substantially static central part 32′-1 of the phase corrector 32′, the area of the dome 31 that moves and generates sound waves is reduced. Whilst clamping the central part of the dome 31 does reduce the acoustic energy produced by the dome 31, the reduction is relatively small because (as mentioned above) most of the sound energy radiated from the dome 31 comes from the peripheral regions of the dome 31.

This has two consequential benefits:
a) The phase corrector 32′ can be simplified to allow for fewer channels for the sound waves to travel through.
b) The dome 31 itself can be made of a lighter and less rigid material, typically a plastic composite material as opposed to aluminium or titanium that is traditionally used.

These two benefits also allow for better performance and lower costs. As those skilled in the art will appreciate this new design of phase corrector 32′ may be used with the magnetic circuit shown in FIG. 2 or with a conventional design of magnetic circuit.

In the above embodiment, the magnet 11 is a permanent magnet. In other embodiments, the magnet 11 may be an electro-magnet.

Various other modifications will be apparent to those skilled in the art and will not be described in further detail here.

1. A magnetic assembly for a loudspeaker comprising:
a magnet for producing a magnetic field;
a top plate provided adjacent a top surface of the magnet;
a rear plate provided adjacent a rear surface of the magnet;
a pole piece positioned adjacent the top plate and the rear plate;
a first projection that projects from an inside surface of the pole piece;
a second projection that projects from a surface of the rear plate;
wherein the pole piece and the top plate are positioned adjacent each other to define a first air gap for a first voice coil;
wherein the first projection and the second projection are arranged adjacent each other to define a second air gap for a second voice coil.

2. A magnetic assembly according to claim 1, wherein the pole piece and the rear plate are positioned adjacent each other to define a third gap.

3. A magnetic assembly according to claim 2, wherein the third gap is defined by one or more non-magnetic spacers.

4. A magnetic assembly according to claim 3, wherein the one or more non-magnetic spacers locate and fix the pole piece relative to the rear plate.

5. A magnetic assembly according to claim 3, wherein the spacer is configured so that the third gap is between 1 mm and 2 mm.

6. A magnetic assembly according to claim 1, wherein the magnet is a ring magnet, made out of a ferrite material.

7. A magnetic assembly according to claim 1, wherein the top plate and the rear plate have an annular shape.

8. A magnetic assembly according to claim 7, wherein the pole piece is positioned within an inner edge of the annular top plate.

9. A magnetic assembly according to claim 8, wherein the pole piece is substantially cylindrical.

10. A magnetic assembly according to claim 1, wherein the first projection has an annular shape.

11. A magnetic assembly according to claim 10, wherein the first projection is positioned closer to a base of the pole piece than to a top of the pole piece.

12. A magnetic assembly according to claims 1, wherein the first projection is integrally formed with the pole piece.

13. A magnetic assembly according to claim 1, wherein the pole piece, the first and second projections, the top plate and the rear plate are arranged so that the first air gap and the second air gap are annular having a common central axis.

14. A loudspeaker comprising:
a magnetic assembly according to claim 1;
a frame coupled to the magnetic assembly;
a first voice coil mounted within the first air gap;
a cone attached between the frame and the first voice coil;
a second voice coil mounted within the second air gap; and
a dome attached to the second voice coil.

15. A loudspeaker according to claim 14, wherein the dome is convex in shape relative to a propagation direction of a sound wave produced by the loudspeaker.

16. A loudspeaker according to claim 14, wherein the first and second voice coils are coaxial and wherein the dome and the cone are positioned so that sound waves produced by the dome are guided by the cone.

17. A loudspeaker according to claim 16, further comprising a phase corrector positioned in front of the dome for correcting a phase of the sound wave produced by the dome.

18. A loudspeaker according to claim 16, wherein the second voice coil has a smaller diameter than the diameter of the first voice coil.

19. A coaxial loudspeaker comprising:
a frame coupled to a magnetic assembly;
a first voice coil mounted within a first air gap of the magnetic assembly;
a cone attached between the frame and the first voice coil;
a second voice coil mounted within a second air gap of the magnetic assembly;
a dome attached to the second voice coil; and
a phase corrector positioned between the dome and the cone for correcting a phase of sound waves produced by the dome;
wherein a central part of the dome is clamped to the phase corrector.

20. A coaxial loudspeaker according to claim 19, wherein the magnetic assembly comprises:
a magnet for producing a magnetic field;
a top plate provided adjacent a top surface of the magnet;
a rear plate provided adjacent a rear surface of the magnet;
a pole piece positioned adjacent the top plate and the rear plate;
a first projection that projects from an inside surface of the pole piece;
a second projection that projects from a surface of the rear plate;
wherein the pole piece and the top plate are positioned adjacent each other to define a first air gap for a first voice coil;
wherein the first projection and the second projection are arranged adjacent each other to define a second air gap for a second voice coil.
